(19) United States
(12) Patent Application Publication
(10) Pub. No.: US 2025/0150784 A1
(43) Pub. Date: May 8, 2025

(54) INFORMATION PROCESSING SYSTEM AND INFORMATION PROCESSING METHOD

(71) Applicant: SONY SEMICONDUCTOR SOLUTIONS CORPORATION, KANAGAWA (JP)

(72) Inventor: SHU SAIKAWA, KANAGAWA (JP)

(21) Appl. No.: 18/835,552

(22) PCT Filed: Feb. 2, 2023
(86) PCT No.: PCT/JP2023/003340

§ 371 Date: Aug. 2, 2024

(30) Foreign Application Priority Data
Feb. 14, 2022 (JP) 2022-020339

(51) Int. Cl. H04W 4/02

(52) U.S. Cl. CPC H04W 4/027

(57) ABSTRACT

The present technology relates to an information processing system and an information processing method capable of determining what cannot be determined with single data by sharing acceleration data between a plurality of devices. Whether or not a first device and a second device that are attachably and detachably worn on a predetermined portion so as to face each other are in a relationship of facing positions is determined on the basis of a first acceleration and a second acceleration that are accelerations of the first device and the second device, respectively, and the attached and detached state of the first device and the second device is detected. Alternatively, an acceleration of a first device is transmitted to a second device connected to the first device by wireless communication, through the wireless communication.

### TECHNICAL FIELD

The present technology relates to an information processing system and an information processing method, and more particularly to an information processing system and an information processing method capable of determining what cannot be determined with single data by sharing acceleration data among a plurality of devices.

### BACKGROUND ART

Patent Document 1 discloses that a sensor which detects attachment/detachment to/from a user is attached to a mounting portion of a wearable device.

### CITATION LIST

### Patent Document

Patent Document 1: Japanese Patent Application Laid-Open No. 2020-31444

### SUMMARY OF THE INVENTION

### Problems to be Solved by the Invention

Acceleration sensors are mounted on various devices, and acceleration data detected by the acceleration sensor is used for various purposes. If the acceleration data can be shared among a plurality of devices, what cannot be determined with single data can be determined, and the acceleration sensor can be more effectively used in combination with use in other applications.

The present technology has been made in view of such a situation, and makes it possible to determine what cannot be determined with single data by sharing acceleration data among a plurality of devices.

### Solutions to Problems

An information processing system according to a first aspect of the present technology is an information processing system including: a processing unit that determines whether or not a first device and a second device that are attachably and detachably worn on a predetermined portion so as to face each other are in a relationship of facing positions on the basis of a first acceleration and a second acceleration that are accelerations of the first device and the second device, respectively, and detects an attached and detached state of the first device and the second device.

An information processing method according to a first aspect of the present technology is an information processing method including: by a processing unit of an information processing system including the processing unit, determining whether or not a first device and a second device that are attachably and detachably worn on a predetermined portion so as to face each other are in a relationship of facing positions on the basis of a first acceleration and a second acceleration that are accelerations of the first device and the second device, respectively, and detecting an attached and detached state of the first device and the second device.

In the information processing system and the information processing method according to the first aspect of the present technology, whether or not a first device and a second device that are attachably and detachably worn on a predetermined portion so as to face each other are in a relationship of facing positions is determined on the basis of a first acceleration and a second acceleration that are accelerations of the first device and the second device, respectively, and an attached and detached state of the first device and the second device is detected.

An information processing system according to a second aspect of the present technology is an information processing system including a communication unit that transmits an acceleration of a first device to a second device connected to the first device by wireless communication, through the wireless communication.

In the information processing system according to the second aspect of the present technology, an acceleration of a first device is transmitted to a second device connected to the first device by wireless communication through the wireless communication.

### BRIEF DESCRIPTION OF DRAWINGS

FIG. 1 is a block diagram illustrating a configuration example of an information processing system according to an embodiment of the present technology.

FIG. 2 is a view illustrating examples of appearances of a TWS (L) and a TWS (R).

FIG. 3 is a view illustrating an overview of the present technology.

FIG. 4 is a view illustrating the overview of the present technology.

FIG. 5 is a diagram illustrating each of the attached and detached states of the TWS (L) and the TWS (R) to and from the user's ears and a process example according to transition between the attached and detached states.

FIG. 6 is a block diagram illustrating attached and detached state detection according to a first mode.

FIG. 7 is a flowchart illustrating an example of a processing procedure of the attached and detached state detection according to the first mode.

FIG. 8 is a diagram illustrating a determination process in a state determination unit.

FIG. 9 is a block diagram illustrating attached and detached state detection according to a second mode.

FIG. 10 is a flowchart illustrating an example of a processing procedure of attached and detached state detection according to the second mode.

FIG. 11 is a flowchart illustrating an example of the processing procedure of the attached and detached state detection according to the second mode.

FIG. 12 is a flowchart illustrating an example of the procedure in the case of detecting the attached and detached state of the TWS (L) and the TWS (R) by always using an auxiliary sensor.

### MODE FOR CARRYING OUT THE INVENTION

Hereinafter, an embodiment of the present technology will be described with reference to the drawings.

### <Embodiment of Information Processing System>

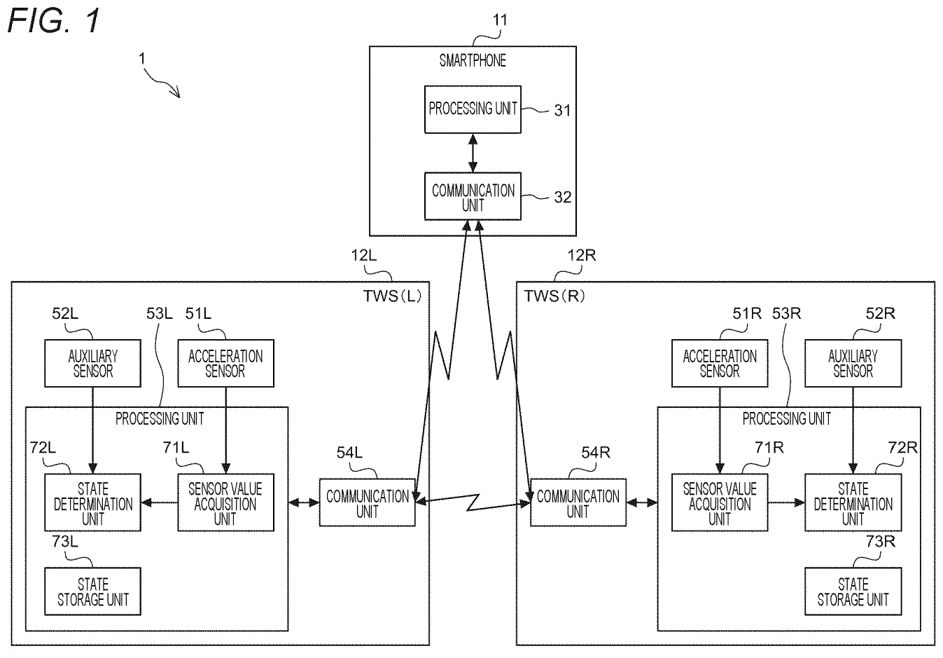

FIG. 1 is a block diagram illustrating a configuration example of an information processing system according to an embodiment of the present technology.

In FIG. 1, an information processing system 1 which is an embodiment of the information processing system to which the present technology is applied includes a smartphone 11, a true wireless stereo (left) (TWS (L)) 12L, and a true wireless stereo (right) (TWS (R)) 12R.

Any two devices among the smartphone 11, the TWS (L) 12L, and the TWS (R) 12R can be connected by wireless communication conforming to a predetermined communication standard. In the present embodiment, it is assumed that it is possible to connect the smartphone 11 and each of the TWS (L) 12L and the TWS (R) 12R and connect the TWS (L) 12L and the TWS (R) 12R by wireless communication conforming to the Bluetooth (registered trademark) Low Energy standard (hereinafter referred to as BLE), which is one of the Bluetooth (registered trademark) standards. Hereinafter, connection by BLE wireless communication between devices is simply referred to as connection, connection by BLE, or the like. With respect to a communication unit of each device that performs connection by BLE wireless communication between the devices, a state in which connection by the wireless communication is performed is a state in which wireless communication of the communication unit is valid, and a state in which connection by the wireless communication is not performed is a state in which wireless communication of the communication unit is invalid.

However, the wireless communication standard for connecting the devices may be any standard other than BLE, or all the wireless communication for connecting the devices may not be the same standard.

The smartphone 11 is a known information processing device. As the configuration units related to wireless communication with the TWS (L) 12L and the TWS (R) 12R among the configuration units included in the smartphone 11, there are a processing unit 31 and a communication unit 32.

The processing unit 31 executes a program stored in a storage unit (not illustrated) and executes processing according to the program. The processing unit 31 supplies to the communication unit 32 data (data body) such as audio data to be transmitted to the TWS (L) 12L or the TWS (R) 12R connected to the smartphone 11. The processing unit 31 acquires data transmitted by the TWS (L) 12L or the TWS (R) 12R connected to the smartphone 11 via the communication unit 32.

The communication unit 32 performs processing such as encapsulation and modulation on the data supplied from the processing unit 31. As a result, the communication unit 32 generates transmission data (packet having a predetermined bit length) conforming to BLE, and transmits the transmission data as a radio wave to the TWS (L) 12L or the TWS (R) 12R. The communication unit 32 receives transmission data transmitted as a radio wave by the TWS (L) 12L or the TWS (R) 12R connected to the smartphone 11. The communication unit 32 performs processing such as demodulation and non-encapsulation on the received transmission data, and supplies the data to the processing unit 31.

Note that the smartphone 11 is an example, and any device such as a personal computer, a music reproducing device, or a mobile terminal is possible.

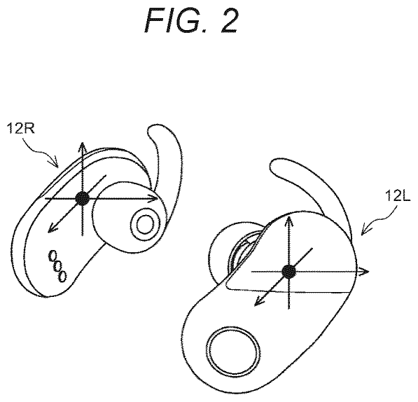

The TWS (L) 12L and the TWS (R) 12R represent audio output devices such as earphones compatible with true wireless stereo. FIG. 2 illustrates examples of the appearances of the TWS (L) 12L and the TWS (R) 12R which are earphones, and the TWS (L) 12L and TWS (R) 12R are used in a combination of a left (for left-side arrangement) earphone to be worn on the left ear and a right (for right-side arrangement) earphone to be worn on the right ear. Note that, in the following description, the TWS (L) 12L and the TWS (R) 12R are denoted by TWS (L) and TWS (R), respectively, without any reference signs. The TWS (L) 12L and the TWS (R) 12R are examples, and the present technology can be applied to two devices that are attachably and detachably worn on a predetermined portion such as a head (in particular, ears) so as to face each other.

In FIG. 1, the TWS (L) includes an acceleration sensor 51L, an auxiliary sensor 52L, a processing unit 53L, and a communication unit 54L. The acceleration sensor 51L detects acceleration in three orthogonal axial directions. A detection signal (acceleration data) of the acceleration sensor 51L is supplied to the processing unit 53L. The auxiliary sensor 52L detects contact with an ear. For example, the auxiliary sensor 52L is not limited to a specific type as long as it is a sensor that detects proximity or contact of an object, such as a proximity sensor, a contact sensor, or a pulse wave sensor. A detection signal of the auxiliary sensor 52L is supplied to the processing unit 53L.

The processing unit 53L executes a program stored in a storage unit (not illustrated) and executes processing according to the program. The processing unit 53L supplies data (data body) to be transmitted to the smartphone 11 or the TWS (R) connected to the TWS (L) 12 to the communication unit 54L. The processing unit 53L acquires data transmitted by the smartphone 11 or the TWS (R) connected to the TWS (L) via the communication unit 54L. Furthermore, the processing unit 53L detects the attached and detached state of the TWS (L) and the TWS (R). In the processing unit 53L, an example of the functional configuration related to detection of the attached and detached state is illustrated. The processing unit 53L includes a sensor value acquisition unit 71L, a state determination unit 72L, and a state storage unit 73R.

The sensor value acquisition unit 71L acquires a sensor value (acceleration data) detected by the acceleration sensor 51L. Furthermore, the sensor value acquisition unit 71L acquires a sensor value (acceleration data) detected by the acceleration sensor 51R of the TWS (R) through the communication unit 54L.

The state determination unit 72L determines the attached and detached state of the TWS (L) and the TWS (R) on the basis of the sensor value acquired by the sensor value acquisition unit 71 or information stored in the state storage unit 73L.

The state storage unit 73L stores the current attached and detached state of the TWS (L) determined by the state determination unit 72L. The state storage unit 73L may store the attached and detached state of the TWS (L) and the TWS (R).

The communication unit 54L performs processing such as encapsulation and modulation on the data supplied from the processing unit 53L. As a result, the communication unit 54L generates transmission data (packet having a predetermined bit length) conforming to BLE, and transmits the transmission data as a radio wave to the smartphone 11 or the TWS (R) connected to the TWS (L). The communication unit 54L receives transmission data (packet) transmitted as a radio wave by the smartphone 11 or the TWS (R) connected to the TWS (L). The communication unit 54L performs processing such as demodulation and non-encapsulation on the received transmission data, and supplies the data to the processing unit 53L.

The TWS (R) includes an acceleration sensor 51R, an auxiliary sensor 52R, a processing unit 53R, and a communication unit 54R. The acceleration sensor 51R, the auxiliary sensor 52R, the processing unit 53R, and the communication unit 54R correspond to the acceleration sensor 51L, the auxiliary sensor 52L, the processing unit 53L, and the communication unit 54L of the TWS (L), respectively, and are configuration units that perform similar processing performed by them, and thus, description thereof is omitted.

Note that, in the present specification, a system means an assembly of a plurality of components (devices, modules (parts), and the like), and it does not matter whether or not all the components are located in the same housing. Therefore, a plurality of devices accommodated in separate housings and connected via a network and one device in which a plurality of modules is accommodated in one housing are both systems.

### (Connection Form)

In a case where the TWS (L) and the TWS (R) are connected to the smartphone 11 by BLE and data communication of the generic attribute profile (GATT) specification is performed, for example, there are the following connection forms. In one connection form, the smartphone 11 is set as a master, and either one (for example, the TWS (L)) of the TWS (L) and the TWS (R) is connected as a slave to the smartphone 11. The TWS (L) connected as the slave to the smartphone 11 simultaneously becomes a master with respect to the other TWS (R), the TWS (R) becomes a slave, and the TWS (L) and the TWS (R) are connected. Accordingly, for example, in a case where stereo audio data is transmitted from the smartphone 11 to the TWS (L), the TWS (L) separates the stereo audio data into left audio data and right audio data. The TWS (L) reproduces the left audio data. The TWS (L) transmits the separated right audio data to the TWS (R), and the TWS (R) reproduces the right audio data.

In another connection form, the smartphone 11 is set as a master, and the TWS (L) and the TWS (R) are individually connected as slaves to the smartphone 11. In this case, when the smartphone 11 has a function of individually transmitting left audio data and right audio data, the left audio data is transmitted from the smartphone 11 to the TWS (L), and the TWS (L) reproduces the left audio data. The right audio data is transmitted from the smartphone 11 to the TWS (R), and the TWS (R) reproduces the right audio data. Only one of the TWS (L) and the TWS (R) is connected to the smartphone 11 to reproduce audio data in some cases.

In a case where the TWS (L) and the TWS (R) are connected to the smartphone 11 by BLE and perform broadcast communication, the TWS (L) and the TWS (R) are individually connected to the smartphone 11 with the smartphone 11 as a slave (broadcaster) and the TWS (L) and the TWS (R) as masters (observers). In this case, for example, if the same audio data is transmitted from the smartphone 11 to the TWS (L) and the TWS (R), each of the TWS (L) and the TWS (R) reproduces the audio data.

### Overview of Present Technology

Each of the TWS (L) and the TWS (R) is wireless and have a built-in rechargeable battery. Therefore, low power consumption is important. As the attached and detached states of the TWS (L) and the TWS (R) to and from the ears, there are a both-ear worn state in which both of the TWS (L) and the TWS (R) are worn on the ears, a one-ear worn state in which one of the TWS (L) and the TWS (R) is worn on the ear, and a non-worn state in which both the TWS (L) and the TWS (R) are not worn on the ear. In the one-ear worn state, the TWS (L) or the TWS (R) that is not worn on the ear is not used for listening to audio data. In the non-worn state, both the TWS (L) and the TWS (R) are not used for listening to audio data. Therefore, according to the worn state of the TWS (L) and the TWS (R), connection (pairing) using BLE is not performed for and audio data is not supplied to the TWS which is either the TWS (L) or the TWS (R) and is not worn on the ear, so that wasteful power consumption can be reduced. For the TWS not worn on the ear, not only connection using BLE is not performed (wireless communication is disabled), but also the power can be turned off. However, it takes time and effort for the user to change the connection state by BLE of each of the TWS (L) and the TWS (R) or change the reproduction state of audio data every time the attached and detached state of the TWS (L) and the TWS (R) is changed.

Patent Document 1 (Japanese Patent Application Laid-Open No. 2020-31444) discloses that a sensor for detecting attachment/detachment to/from a user is attached to a mounting portion of a wearable device, but does not disclose a specific method. Furthermore, it is also conceivable to detect contact with the TWS (L) and the TWS (R) by a sensor and detect the attached and detached state. However, there are cases in which portions other than the ears are in contact with the TWS (L) and the TWS (R), and malfunction is likely to occur.

In the present technology, as described below, the attached and detached state of the TWS (L) and the TWS (R) is detected using acceleration sensors. It is effective to enable the acceleration sensors of the TWS (L) and the TWS (R) to detect the attached and detached state of the TWS (L) and the TWS (R) also in that the acceleration sensors can be used for other purposes (such as user operation detection) in addition to detection of the attached and detached state. That is, in the present technology, by using both of the pieces of acceleration data detected by the acceleration sensors of the TWS (L) and the TWS (R), it is possible to determine the attached and detached state of the TWS (L) and the TWS (R) that cannot be determined by only one of the pieces of data, and it is possible to effectively use the acceleration sensors together with use in other applications.

The acceleration sensors 51L and 51R included in the TWS (L) and the TWS (R) in FIG. 1, respectively, are three-axis acceleration sensors, and detect acceleration in three directions of X, Y, and Z axes set in the acceleration sensors. The acceleration sensors 51L and 51R assume standard postures (relative postures) when both the TWS (L) and the TWS (R) are worn on the both ears of the user, and are fixed inside the TWS (L) and the TWS (R) such that the X axes, the Y axes, and the Z axes of the acceleration sensors 51L and 51R are parallel to each other at that time. FIG. 2 illustrates examples of the directions of the X, Y, and Z axes of the acceleration sensors 51L and 51R included in the TWS (L) and the TWS (R), respectively.

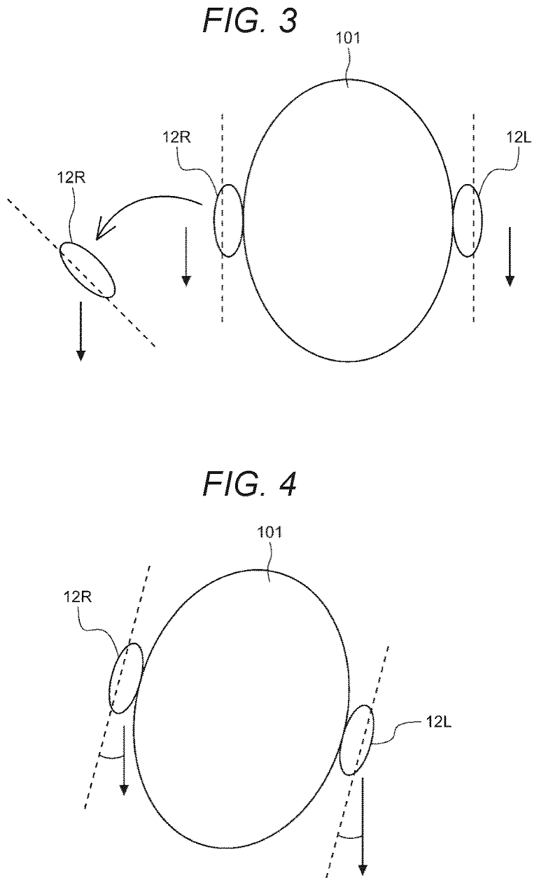

According to this, in the case of the both-ear worn state in which the TWS (L) and the TWS (R) are worn on both ears of a user 101, the TWS (L) and the TWS (R) are in a relationship of facing positions (and postures). In this case, the magnitudes of gravity (gravitational acceleration) with respect to each of the three directions of the X, Y, and Z axes detected by the acceleration sensors 51L and 51R substantially coincide with each other. That is, in other words, in a case where a vector indicating the magnitude and direction of the gravitational acceleration is referred to as a gravity vector, the magnitudes and directions of the gravity vectors (X, Y, Z component values of the gravity vectors) detected in the XYZ coordinate systems of the acceleration sensors 51L and 51R substantially coincide with each other. In contrast, in the case of the one-ear worn state in which the TWS (L) or the TWS (R) is worn on one ear of the user 101, the directions of the gravity vectors detected by the acceleration sensors 51L and 51R do not coincide with each other. FIG. 3 illustrates a state in which the TWS (L) and the TWS (R) are changed from the both-ear worn state to the one-ear worn state. As illustrated in FIG. 3, a case of the both-ear worn state in which the TWS (L) or the TWS (R) is worn on the both ears of the user 101 facing the front, that is, a case where the TWS (L) and TWS (R) are arranged in the relationship of facing positions is assumed. Gravity is downward relative to the head of the user 101. In this case, the acceleration sensors 51L and 51R are installed in the TWS (L) and the TWS (R) such that the magnitudes and directions of the gravity vectors (X, Y, Z components of the gravity vectors) detected by the acceleration sensors 51L and 51R coincide with each other. Therefore, the magnitudes and directions of the gravity vectors detected by the acceleration sensors 51L and 51R substantially coincide with each other.

In contrast, when the TWS (R) is removed from the both-ear worn state, the gravity direction is downward, but the direction of the gravity vector detected by the TWS (R) changes, and is different from the direction of the gravity vector detected by the TWS (L). If the user 101 tilts the head in the both-ear worn state as illustrated in FIG. 4, the directions of the gravity vectors detected by the acceleration sensors 51L and 51R change, but the magnitudes and directions of the gravity vectors are maintained in a matched state.

In this manner, the acceleration sensors 51L and 51R of the TWS (L) and the TWS (R) detect whether or not the TWS (L) and the TWS (R) are in the relationship of facing positions by using gravity, and detect whether or not the state is the both-ear worn state. However, in a case where the TWS (L) and the TWS (R) are not in the relationship of facing positions, it is not possible to determine whether the state is the non-worn state or the one-ear worn state. Therefore, it is determined whether the state is the non-worn state or the one-ear worn state by appropriately using the change in acceleration of the TWS (L) and the TWS (R) generated with respect to the attached and detached state before transitioning to the non-worn state or the one-ear worn state and output values of the auxiliary sensors 52L and 52R.

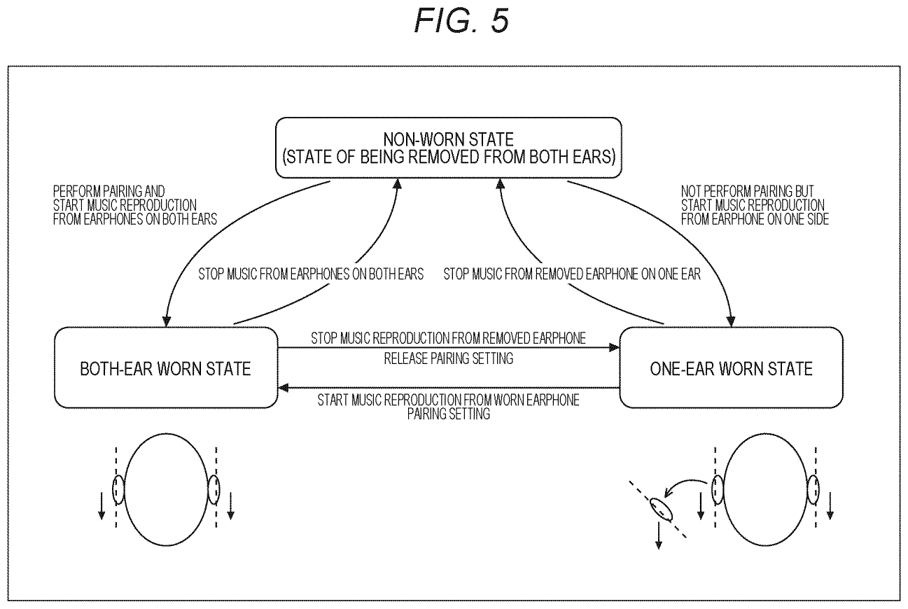

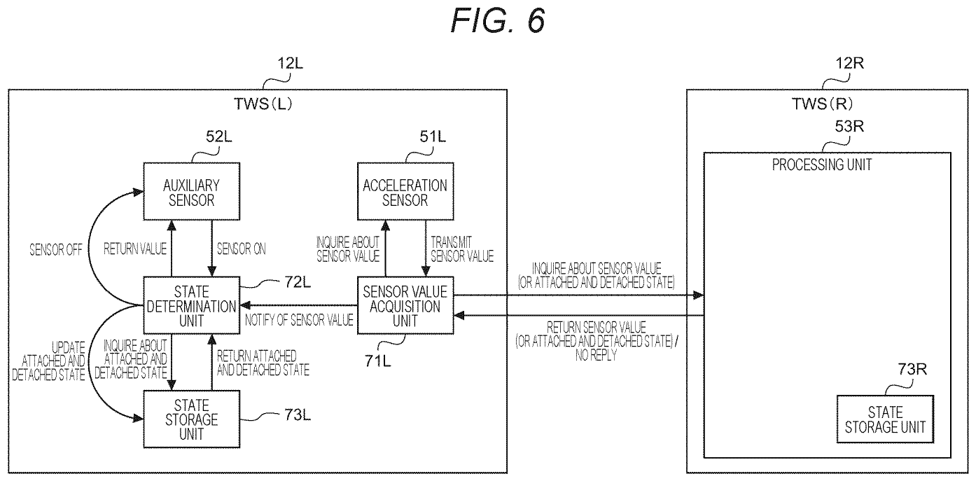

FIG. 5 is a diagram illustrating each of the attached and detached states of the TWS (L) and the TWS (R) to and from the user's ears and a process example according to transition between the attached and detached states. FIG. 5 illustrates three attached and detached states, that is, the both-ear worn state, the one-ear worn state, and the non-worn state, as the attached and detached states of the TWS (L) and the TWS (R).

In a case where the state transitions from the non-worn state to the both-ear worn state, connection (pairing) by BLE is performed between the smartphone 11 and each of the TWS (L) and the TWS (R), and audio (music or the like) reproduction from the TWS (L) and the TWS (R) is started. Note that the connection between the smartphone 11 and each of the TWS (L) and the TWS (R) by BLE may be, for example, any of the case of connection between the smartphone 11 and the TWS (L) and between the TWS (L) and the TWS (R), and the case of connection between the smartphone 11 and the TWS (L) and between the smartphone 11 and the TWS (R). The process of starting and stopping audio reproduction is a process by an audio reproduction application executed in the processing unit 31 of the smartphone 11.

In a case where the state transitions from the both-ear worn state to the non-worn state, connection (pairing) between the smartphone 11 and each of the TWS (L) and the TWS (R) is released, and audio (music or the like) reproduction from the TWS (L) and the TWS (R) is stopped.

In a case where the state transitions from the non-worn state to the one-ear worn state, connection (pairing) is performed between the smartphone 11 and the TWS (L) or the TWS (R) worn on the ear, and audio (music or the like) reproduction from the TWS (L) or the TWS (R) worn on the ear is started. Note that, out of the TWS (L) and the TWS (R), the TWS worn on the ear is denoted by a TWS (X), and the TWS not worn on the ear is denoted by a TWS (−X). In a case where the state transitions from the one-ear worn state to the non-worn state, connection (pairing) between the smartphone 11 and the TWS (X) is released, and audio reproduction from the TWS (X) is stopped.

In a case where the state transitions from the both-ear worn state to the one-ear worn state, connection (pairing) between the smartphone 11 and the TSW (−X) removed from the ear (not worn on the ear) is released, and audio reproduction from the TWS (−X) is stopped.

In a case where the state transitions from the one-ear worn state to the both-ear worn state, connection (pairing) between the smartphone 11 and the TSW (X) to be worn on the ear is performed, and audio reproduction from the TWS (X) is started.

### <<Details of Attached and Detached State Detection>>

Detection of the attached and detached state of the TWS (L) and the TWS (R) is performed when an acceleration change that occurs when attachment/detachment operation of either the TWS (L) or the TWS (R) to/from the ear is performed is detected. Different from an acceleration change at the time of walking or the like, the attachment/detachment operation of the TWS (L) or the TWS (R) to/from the ear generates a great acceleration in one direction, so that it is possible to determine whether or not the attachment/detachment operation is performed from the acceleration change.

Detection of the attached and detached state of the TWS (L) and the TWS (R) will be described separately in a first mode in which the detection is performed by the TWS which is one of the TWS (L) and the TWS (R) and attachment/detachment operation of which is performed and a second mode in which the detection is performed by the TWS which is one of the TWS (L) and the TWS (R) and attachment/detachment operation of which is not performed. Regarding which one of the TWS (L) and the TWS (R) performs the detection of the attached and detached state of the TWS (L) and the TWS (R), there may be any mode other than the first mode and the second mode, and detection of the attached and detached state in any mode can be performed by application of the first mode and the second mode.

### <Attached and Detached State Detection According to First Mode>

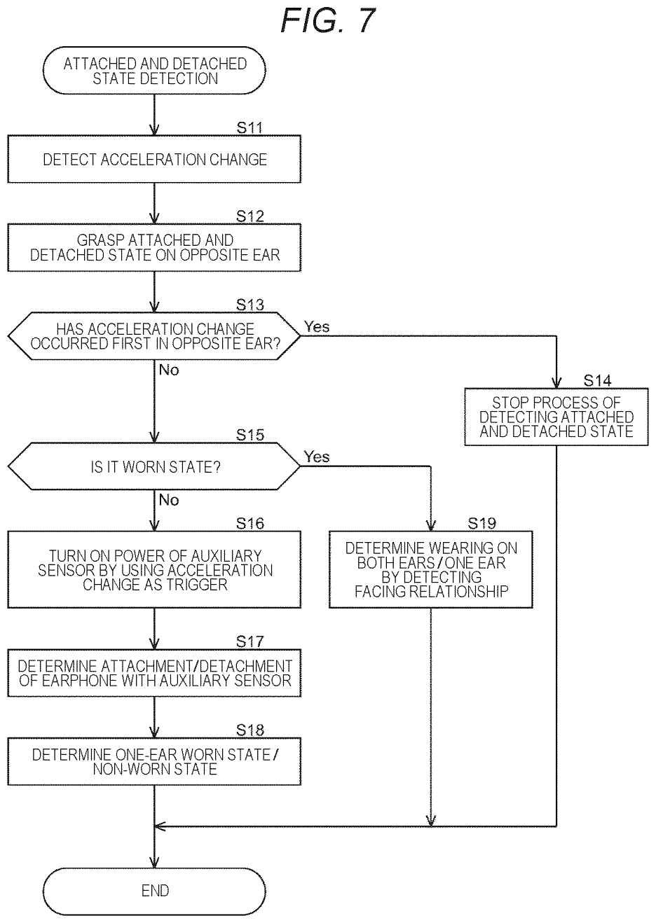

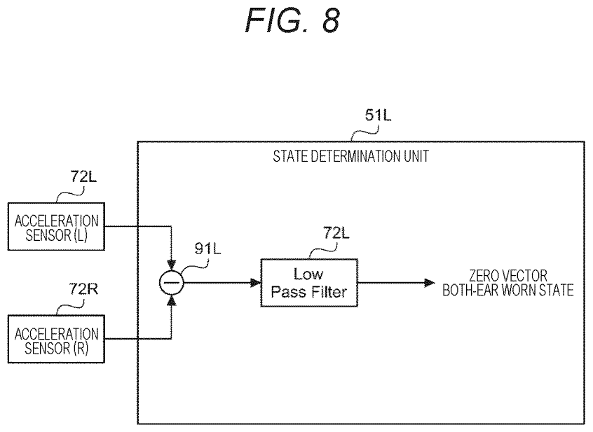

Attached and detached state detection according to the first mode of the TWS (L) and the TWS (R) will be described with reference to FIGS. 6 to 8 as appropriate. FIG. 6 is a diagram extracting and illustrating blocks used for the attached and detached state detection according to the first mode in the information processing system 1 of FIG. 1. However, since the configuration of the TWS (R) is similar to that of the TWS (L), illustration thereof is omitted. FIG. 7 is a flowchart illustrating an example of the processing procedure of the attached and detached state detection according to the first mode. FIG. 8 is a diagram illustrating a determination process in the state determination unit 72L (72R).

The attached and detached state detection according to the first mode is performed in the TWS attachment/detachment operation of which is performed. In the present description, attachment/detachment operation of the TWS (L) is performed, and attention is paid to attached and detached state detection performed by the TWS (L). A case where attachment/detachment operation of the TWS (R) is performed and the TWS (R) detects the attached and detached state is different only in that the TWS (R) performs the process of detecting the attached and detached state performed by the TWS (L), and thus the description thereof will be omitted.

In FIG. 6, when the power is turned on, the sensor value acquisition unit 71L of the TWS (L) inquires of the acceleration sensor 51L about the sensor value (acceleration data), and starts to acquire the sensor value from the acceleration sensor 51L at a predetermined cycle. The state determination unit 72L is notified of the acquired sensor value. When detecting an acceleration change indicating that attachment/detachment operation of the TWS (L) is performed (hereinafter, also simply referred to as an acceleration change) on the basis of the sensor value from the sensor value acquisition unit 71L (step S11 in FIG. 7), the state determination unit 72L determines that the attached and detached state of the TWS (L) is an attachment/detachment operation state in which attachment/detachment operation is performed. When determining that the TWS (L) is in the attachment/detachment operation state, the state determination unit 72L grasps the attached and detached state of the TWS (R) (step S12 in FIG. 7). The attached and detached state of the TWS (R) is grasped by the state determination unit 72L of the TWS (L) by, for example, the following method. Note that, in the block diagram of FIG. 6, the communication units 54L and 54R are omitted, and in the following description, the communication units 54L and 54R are omitted unless it is necessary to use communication such as BLE for exchanging information between the TWS (L) and the TWS (R).

When the state determination unit 72L of the TWS (L) determines that the TWS (L) is in the attachment/detachment operation state, the sensor value acquisition unit 71L inquires of the sensor value acquisition unit 71R of the TWS (R) about the sensor value (acceleration data). In response to the inquiry about the sensor value, the sensor value acquisition unit 71R acquires the sensor value from the acceleration sensor 51R at a predetermined cycle, and returns the acquired sensor value to the sensor value acquisition unit 71L. The state determination unit 72L acquires the sensor value returned from the sensor value acquisition unit 71R via the sensor value acquisition unit 71L, and grasps the attached and detached state of the TWS (R) on the basis of the acquired sensor value. Here, in a case where a reply (response) from the sensor value acquisition unit 71R cannot be obtained, the power of the TWS (R) is turned off, and the state determination unit 72L determines (regards) that the TWS (R) is in the non-worn state where the TWS (R) is not worn on the right ear. In a case where a reply (response) from the sensor value acquisition unit 71R is obtained, when an acceleration change indicating that attachment/detachment operation is performed occurs in the sensor value obtained as the reply, the state determination unit 72L determines that the TWS (R) is in the attachment/detachment operation state in which attachment/detachment operation is being performed. When an acceleration change indicating that attachment/detachment operation is performed does not occur in the sensor value obtained as a reply, that is, when the state is not the attachment/detachment operation state, the state determination unit 72L determines whether the TWS (R) is in the worn state in which the TWS (R) is worn on the right ear or in the non-worn state in which the TWS (R) is not worn on the right ear on the basis of the information of the attached and detached state of the TWS (R) stored in the state storage unit 73R. In the case of acquiring information on the attached and detached state stored in the state storage unit 73R, the state determination unit 72L causes the sensor value acquisition unit 71L to inquire of the sensor value acquisition unit 71R about the attached and detached state of the TWS (R), and acquires, as a reply, the information on the attached and detached state stored in the state storage unit 73R via the sensor value acquisition unit 71R and the sensor value acquisition unit 71L. Note that in a case where information on whether or not the TWS (R) is in the attachment/detachment operation state is stored in the state storage unit 73R, the state determination unit 72L may determine (grasp) which of the worn state, the non-worn state, or the attachment/detachment operation state the TWS (R) is in, by acquiring information on the attached and detached state in the state storage unit 73R. Furthermore, in a case where the information on the attached and detached state of the TWS (R) is stored in the state storage unit 73L, the state determination unit 72L may grasp whether the TWS (R) is in the worn state or the non-worn state on the basis of the information on the attached and detached state of the TWS (R) acquired by inquiring of the state storage unit 73L.

When the state determination unit 72L grasps the attached and detached state of the TWS (R), the state determination unit 72L determines whether or not the acceleration change of the TWS (R) has occurred before that of the TWS (L), that is, whether or not the TWS (R) has become the attachment/detachment operation state before the TWS (L) in a case where the TWS (R) is in the attachment/detachment operation state (step S13 in FIG. 7). Whether or not the acceleration change of the TWS (R) has occurred before that of the TWS (L) can be determined by whether or not the sensor value acquisition unit 71R of the TWS (R) inquired of the TWS (L) about the sensor value or the attached and detached state before the TWS (L) inquires about the sensor value or the attachment state. In a case where it is determined that the acceleration change of the TWS (R) has occurred before that of the TWS (L), the state determination unit 72L stops the process of detecting the attached and detached state (step S14 in FIG. 7). That is, in a case where an acceleration change (attachment/detachment operation) has occurred in both the TWS (L) and the TWS (R), one of the TWS (L) and the TWS (R) in which the acceleration change has occurred first performs the process of detecting the attached and detached state, and the other returns only the sensor value to the one of the TWS (L) and the TWS (R) without performing the process of detecting the attached and detached state. Note that the TWS in which the acceleration change has occurred later may perform the process of detecting the attached and detached state.

In a case where the state determination unit 72L does not determine that the acceleration change of the TWS (R) has occurred before that of the TWS (L) (including a case where the acceleration change has not occurred in the TWS (R)), the state determination unit 72L determines whether or not the attached and detached state of the TWS (R) is the worn state (step S15 in FIG. 7). Note that the state determination unit 72L periodically and continuously acquires the sensor values of the acceleration sensors 51L and 51R, and performs the determination in step S15 in FIG. 7 after the acceleration change indicating that the attachment/detachment operation of the TWS (L) is being performed is no longer detected. In a case where it is determined that the TWS (R) is in the non-worn state or the attachment/detachment operation state, the state determination unit 72L cannot detect the attached and detached state of the TWS (L) on the basis of the relationship of facing positions of the TWS (L) and the TWS (R), and thus, the state determination unit 72L turns on the auxiliary sensor 52L and acquires a value returned from the auxiliary sensor 52L (step S16 in FIG. 7). The state determination unit 72L determines whether or not the TWS (L) is in the worn state on the basis of the value acquired from the auxiliary sensor 52L (step S17 in FIG. 7). In a case where it is detected from the value from the auxiliary sensor 52L that there is an object close to or in contact with the TWS (L), the state determination unit 72L determines that the TWS (L) is in the worn state. In a case where it is detected from the value from the auxiliary sensor 52L that there is no object close to or in contact with the TWS (L), the state determination unit 72L determines that the TWS (L) is in the non-worn state. Here, since the TWS (R) is in the non-worn state or the attachment/detachment operation state, in a case where it is determined that the TWS (L) is in the worn state, the state determination unit 72L determines that the attached and detached state of the TWS (L) and the TWS (R) is the one-ear worn state (the worn state of only the TWS (L)). In the case of determining that the TWS (L) is in the non-worn state, the state determination unit 72L determines that the attached and detached state of the TWS (L) and the TWS (R) is the non-worn state (step S18 in FIG. 7). After determining the attached and detached state, the state determination unit 72L turns off the auxiliary sensor 52L and causes the state storage unit 73L to store the attached and detached state, which is the determination result. Furthermore, the state determination unit 72L transmits the attached and detached state, which is the determination result, to the processing unit 53R of the TWS (R), and causes the state storage unit 72R to store the attached and detached state.

Note that in a case where the TWS (R) is in the attachment/detachment operation state, the state determination unit 72L determines the attached and detached state of the TWS (R) after the acceleration change indicating that the attachment/detachment operation of the TWS (R) is being performed is no longer detected. At this time, in a case where the TWS (L) is in the worn state, the state determination unit 72L detects the attached and detached state of the TWS (L) on the basis of the relationship of facing positions of the TWS (L) and the TWS (R). In a case where the TWS (L) is in the non-worn state, the state determination unit 72L detects the attached and detached state of the TWS (L) on the basis of the value acquired from the auxiliary sensor 52R. The state determination unit 72L causes the state storage unit 73L to store the attached and detached state, which is the determination result. Furthermore, the state determination unit 72L transmits the attached and detached state, which is the determination result, to the processing unit 53R of the TWS (R), and causes the state storage unit 72R to store the attached and detached state.

In a case where the state determination unit 72L determines that the TWS (R) is in the worn state as a result of determining whether or not the TWS (R) is in the worn state (step S15 in FIG. 7), the state determination unit 72L detects the attached and detached state of the TWS (L) on the basis of the relationship of facing positions of the TWS (L) and the TWS (R) (step S19 in FIG. 17). That is, the state determination unit 72L determines whether or not the TWS (L) and the TWS (R) are in the relationship of facing positions on the basis of the sensor value of the acceleration sensor 51L and the sensor value of the acceleration sensor 51R. Specifically, as illustrated in FIG. 8, the state determination unit 72L performs subtraction between the sensor value of the acceleration sensor 51L and the sensor value of the acceleration sensor 51R by using a subtractor 91L for each of the X, Y, and Z components, and then extracts only the low frequency component by a low pass filter 92L. That is, the state determination unit 72L extracts a low-frequency component of a difference vector representing a difference between the gravity vectors detected by the acceleration sensors 51L and 51R. In a case where the difference vector is equal to or smaller than a predetermined threshold, the state determination unit 72L regards the difference vector as 0, determines that the TWS (L) and the TWS (R) are in the relationship of facing positions, and determines that the attached and detached state of the TWS (L) and the TWS (R) is the both-ear worn state. In a case where the difference vector is greater than the predetermined threshold, the state determination unit 72L determines that the TWS (L) is the non-worn state and the attached and detached state of the TWS (L) and the TWS (R) is the one-ear worn state (the worn state of only the TWS (R)). After determining the attached and detached state, the state determination unit 72L causes the state storage unit 73L to store the attached and detached state, which is the determination result. Furthermore, the state determination unit 72L transmits the attached and detached state, which is the determination result, to the processing unit 53R of the TWS (R), and causes the state storage unit 72R to store the attached and detached state.

According to attached and detached state detection according to the first mode of the TWS (L) and the TWS (R) described above, in a case where the TWS (L) and the TWS (R) transition from each of the non-worn state, the one-ear worn state, and the both-ear worn state to each of the non-worn state, the one-ear worn state, and the both-ear worn state, it is possible to detect the attached and detached state after the transition. Note that both the TWS (L) and the TWS (R) may detect the attached and detached state in a case where attachment/detachment operation of both the TWS (L) and the TWS (R) is performed. Since the state of wireless communication or the state of power of each of the TWS (L) and the TWS (R) is automatically switched between enabled and disabled or between on and off in accordance with the worn state thereof, power consumption can be reduced without trouble for the user.

### <Attached and Detached State Detection According to Second Mode>

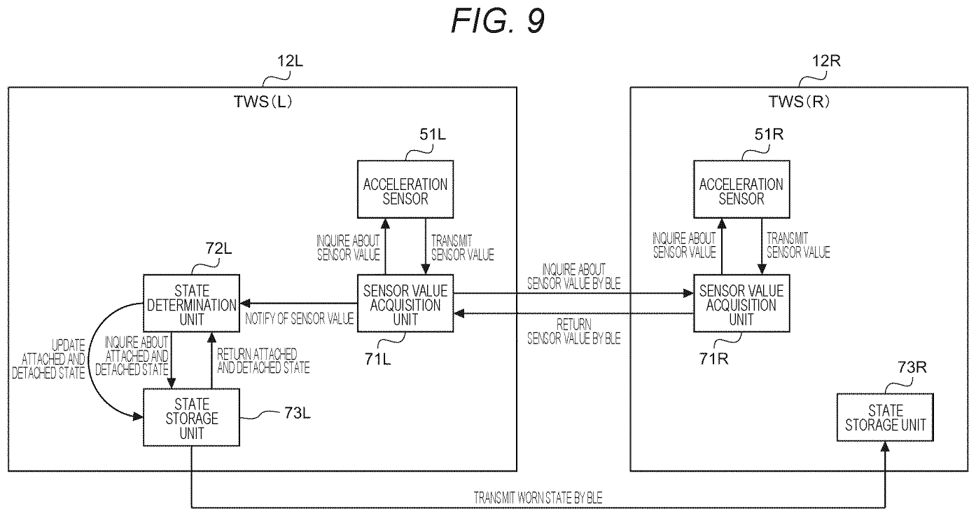

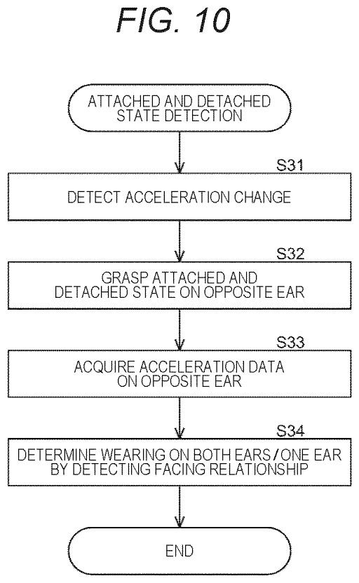

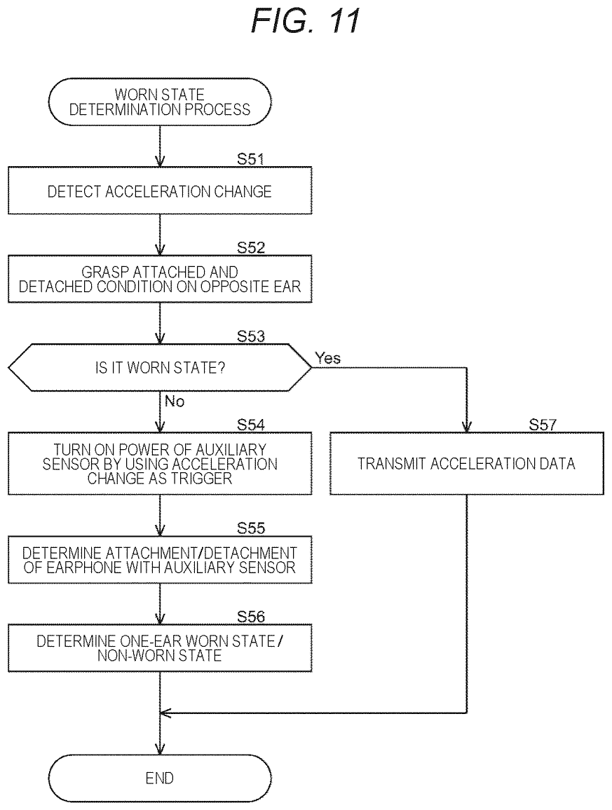

Attached and detached state detection according to a second mode of the TWS (L) and the TWS (R) will be described with reference to FIGS. 9 to 11 as appropriate. FIG. 9 is a diagram extracting and illustrating blocks used for the attached and detached state detection according to the second mode in the information processing system 1 of FIG. 1. FIGS. 10 and 11 are flowcharts illustrating an example of the processing procedure of the attached and detached state detection according to the second mode.

Here, in the attached and detached state detection according to the second mode, in a case where attachment/detachment operation of either the TWS (L) or the TWS (R) is performed, the TWS attachment/detachment operation of which is not performed executes the process of detecting the attached and detached state according to the procedure of FIG. 10. However, in the transition from the non-worn state to the one-ear worn state or the transition from the one-ear worn state to the non-worn state, there is a possibility that the TWS attachment/detachment operation of which is not performed is in the non-worn state and the power supply is turned off, and thus, the TWS attachment/detachment operation of which is performed executes the process of detecting the attached and detached state according to the procedure of FIG. 11. Furthermore, also in a case where attachment/detachment operation of both the TWS (L) and the TWS (R) has been performed, similarly to the attached and detached state detection according to the first mode, the TWS attachment/detachment operation of which has been performed first or later performs the process of detecting the attached and detached state according to the procedure of FIG. 11. Note that in the present description, attention is paid to attached and detached state detection performed by the TWS (L). Attached and detached state detection performed by the TWS (R) is different only in that attached and detached state detection performed by the TWS (L) is performed by the TWS (R), and thus the description thereof will be omitted.

First, it is assumed that attachment/detachment operation of the TWS (L) is not performed but attachment/detachment operation of the TWS (R) is performed. In FIG. 9, the sensor value acquisition unit 71L of the TWS (L) inquires of the acceleration sensor 51L about the sensor value (acceleration data), and starts to acquire the sensor value from the acceleration sensor 51L at a predetermined cycle. The state determination unit 72L is notified of the acquired sensor value. The state determination unit 72L starts detection of an acceleration change indicating that attachment/detachment operation of the TWS (R) is performed (hereinafter simply referred to as an acceleration change) on the basis of the sensor value of the acceleration sensor 51L (step S31 in FIG. 10). Here, it is assumed that the acceleration change is not detected and the TWS (L) is in the worn state. In contrast, when the attachment/detachment operation of the TWS (R) is performed and the sensor value acquisition unit 71R of the TWS (R) inquires about the sensor value or the attached and detached state, the sensor value acquisition unit 71L returns the sensor value of the acceleration sensor 51L to the sensor value acquisition unit 71R, and the state determination unit 72L grasps the attached and detached state of the TWS (R) (step S32 in FIG. 10). The attached and detached state of the TWS (R) is grasped by a method similar to that of the attached and detached state detection according to the first mode (see step S12 in FIG. 7).

In a case where the state determination unit 72L detects that the TWS (R) is in the attachment/detachment operation state as a result of grasping the attached and detached state of the TWS (R), the sensor value acquisition unit 71L inquires of the sensor value acquisition unit 71R of the TWS (R) about the sensor value of the acceleration sensor 51R, and acquires the sensor value returned from the sensor value acquisition unit 71R at a predetermined cycle (step S33 in FIG. 10). The sensor value acquisition unit 71R inquires of the acceleration sensor 51R about the sensor value (acceleration data), acquires the sensor value from the acceleration sensor 51R at a predetermined cycle, and returns the acquired sensor value to the sensor value acquisition unit 71L. The state determination unit 72L is notified of the sensor value of the acceleration sensor 51R returned to the sensor value acquisition unit 71L. Note that the sensor value acquisition unit 71L notifies the state determination unit 72L of the sensor value of the acceleration sensor 51L of the TWS (L) regardless of whether or not attachment/detachment operation of the TWS (R) is performed.

The state determination unit 72L determines whether or not the TWS (L) and the TWS (R) are in the relationship of facing positions on the basis of the sensor value of the acceleration sensor 51L and the sensor value of the acceleration sensor 51R (step S34 in FIG. 10). Since the specific processing is the same as the processing illustrated in FIG. 8, the description thereof will be omitted. Note that the state determination unit 72L performs the determination in step S34 in FIG. 10 after the acceleration change indicating that attachment/detachment operation is being performed is no longer detected in both the TWS (L) and the TWS (R). In the case of determining that the TWS (L) and the TWS (R) are in the relationship of facing positions, the state determination unit 72L determines that the attached and detached state of the TWS (L) and the TWS (R) is the both-ear worn state. In the case of determining that the TWS (R) is in the non-worn state, the state determination unit 72L determines that the attached and detached state of the TWS (L) and the TWS (R) is the one-ear worn state (the worn state of only the TWS (L)). After determining the attached and detached state, the state determination unit 72L causes the state storage unit 73L to store the attached and detached state, which is the determination result. The attached and detached state stored in the state storage unit 73L is transmitted to the TWS (R) and stored in the state storage unit 73R of the TWS (R).

Next, attached and detached state detection in the TWS (L) in a case where the attachment/detachment operation of the TWS (L) is performed will be described. In FIG. 9, the sensor value acquisition unit 71L of the TWS (L) inquires of the acceleration sensor 51L about the sensor value (acceleration data), and starts to acquire the sensor value from the acceleration sensor 51L at a predetermined cycle. The state determination unit 72L is notified of the acquired sensor value. The state determination unit 72L starts detection of an acceleration change indicating that the attachment/detachment operation of the TWS (L) is performed on the basis of the sensor value of the acceleration sensor 51L (step S51 in FIG. 11). In a case where the state determination unit 72L detects an acceleration change indicating that the attachment/detachment operation of the TWS (L) is performed, the sensor value acquisition unit 71L inquires of the sensor value acquisition unit 71R about the sensor value or the attached and detached state, and the state determination unit 72L grasps the attached and detached state of the TWS (R) (step S52 in FIG. 11). Note that the attached and detached state of the TWS (R) is grasped by a method similar to that of the attached and detached state detection according to the first mode (see step S12 in FIG. 7).

The state determination unit 72L determines whether or not the grasped attached and detached state of the TWS (R) is the worn state or the attachment/detachment operation state (step S53 in FIG. 11). Note that in a case where attachment/detachment operation of both the TWS (L) and the TWS (R) has been performed, similarly to the attached and detached state detection according to the first mode, the TWS attachment/detachment operation of which has been performed first or later performs the processing in and after step S53 of FIG. 11. Here, it is assumed that the TWS (L) performs the processing in and after step S53 in FIG. 11. Furthermore, the determination in step S53 in FIG. 11 is performed after the acceleration change indicating that the attachment/detachment operation of the TWS (L) is being performed is no longer detected. In a case where it is determined that the TWS (R) is in the non-worn state or the attachment/detachment operation state, the state determination unit 72L determines whether or not the TWS (L) is in the worn state on the basis of the value acquired from the auxiliary sensor 52L, similarly to steps S16 to 18 in FIG. 7 (steps S54 to S56 in FIG. 11). In the case of determining that the TWS (L) is in the worn state, the state determination unit 72L determines that the attached and detached state of the TWS (L) and the TWS (R) is the one-ear worn state (the worn state of only the TWS (L)). In the case of determining that the TWS (L) is in the non-worn state, the state determination unit 72L determines that the attached and detached state of the TWS (L) and the TWS (R) is the non-worn state. After determining the attached and detached state, the state determination unit 72L turns off the auxiliary sensor 52L and causes the state storage unit 73L to store the attached and detached state, which is the determination result. Furthermore, the state determination unit 72L transmits the attached and detached state, which is the determination result, to the processing unit 53R of the TWS (R), and causes the state storage unit 72R to store the attached and detached state. Note that in a case where the TWS (R) is in the attachment/detachment operation state, the state determination unit 72L determines the attached and detached state of the TWS (R) after the acceleration change indicating that the attachment/detachment operation of the TWS (R) is being performed is no longer detected. At this time, in a case where the TWS (L) is in the worn state, the state determination unit 72L detects the attached and detached state of the TWS (L) on the basis of the relationship of facing positions of the TWS (L) and the TWS (R). In a case where the TWS (L) is in the non-worn state, the state determination unit 72L detects the attached and detached state of the TWS (L) on the basis of the value acquired from the auxiliary sensor 52R. The state determination unit 72L causes the state storage unit 73L to store the attached and detached state, which is the determination result. Furthermore, the state determination unit 72L transmits the attached and detached state, which is the determination result, to the processing unit 53R of the TWS (R), and causes the state storage unit 72R to store the attached and detached state.

In the case of determining that the grasped attached and detached state of the TWS (R) is the worn state (step S53 in FIG. 11), the state determination unit 72L causes the sensor value acquisition unit 71L to transmit the sensor value (acceleration data) of the acceleration sensor 51L to the TWS (R) (step S57 in FIG. 11). As a result, the process of detecting the attached and detached state in FIG. 10 is performed by the TWS (R).

According to attached and detached state detection according to the second mode of the TWS (L) and the TWS (R) described above, in a case where the TWS (L) and the TWS (R) transition from each of the non-worn state, the one-ear worn state, and the both-ear worn state to each of the non-worn state, the one-ear worn state, and the both-ear worn state, it is possible to detect the attached and detached state after the transition. Since the state of wireless communication or the state of power of each of the TWS (L) and the TWS (R) is automatically switched between enabled and disabled or between on and off in accordance with the worn state thereof, power consumption can be reduced without trouble for the user.

### Modifications

In the attached and detached state detection according to the first and second modes, even in a case where whether or not the TWS (L) and the TWS (R) are in the relationship of facing positions is detected on the basis of the sensor values of the acceleration sensors 51L and 51R, attachment/detachment detection may be performed in consideration of the detection results of the auxiliary sensors 52L and 52R so that the detection accuracy is enhanced.

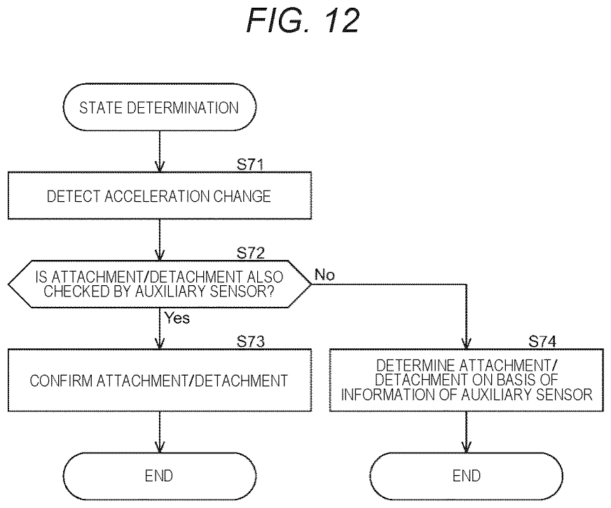

FIG. 12 is a flowchart illustrating an example of the procedure in the case of detecting the attached and detached state of the TWS (L) and the TWS (R) by always using the auxiliary sensor. Note that it is assumed that whether or not the TWS (L) and the TWS (R) are in the relationship of facing positions has been detected. Furthermore, a case where the state determination unit 72L of the TWS (L) determines the attached and detached state will be described. When detecting an acceleration change (step S71), the state determination unit 72L of the TWS (L) turns on the auxiliary sensor 52L, and grasps the attached and detached state of the TWS (L) to and from the ear by the auxiliary sensor 52L. As a result, the state determination unit 72L determines whether or not attachment/detachment is also checked by the auxiliary sensor 52L. That is, the state determination unit 72L determines whether or not the attached and detached state of the TWS (L) and the TWS (R) grasped on the basis of the sensor values of the acceleration sensors 51L and 51R match the attached and detached state of the TWS (L) grasped by the auxiliary sensor 52L. Note that the state determination unit 72L may acquire information of the auxiliary sensor 52R from the TWS (R), and also determine whether or not the attached and detached state of the TWS (R) matches the attached and detached state of the TWS (L) and the TWS (R) grasped on the basis of the sensor values of the acceleration sensors 51L and 51R. In the case of determining that the attached and detached states match, the state determination unit 72L confirms the attached and detached state of the TWS (L) and the TWS (R) (step S73). In the case of determining that the attached and detached states do not match, the state determination unit 72L determines the final attached and detached state of the TWS (L) and the TWS (R) on the basis of information of the auxiliary sensor (step S74).

### <Transmission of Acceleration Data>

In the attached and detached state detection according to the first and second modes, in the TWS (L) and the TWS (R), the sensor values (acceleration data) detected by the acceleration sensors 51L and 51R are appropriately transmitted by BLE from the TWS (L) to the TWS (R) and from the TWS (R) to the TWS (L), respectively. Communication between the TWS (L) and the TWS (R) is not limited to BLE, and may be any wireless or wired communication standard other than BLE. In a case where communication between the TWS (L) and the TWS (R) is performed by communication conforming to the BLE standard or the like, acceleration data may be included in an advertising packet. The advertising packet is data transmitted by using an advertising channel in advertising performed before a slave-side TWS establishes a connection (pairing) with a master-side TWS. Furthermore, in a case where data communication of the GATT specification after connection by BLE is established between the TWS (L) and the TWS (R) is performed, acceleration may be defined as a characteristic of the GATT, and acceleration data detected by the acceleration sensor 51L or 51R may be transmitted as the characteristic of the GATT.

In the above description, the process of detecting the attached and detached state of the TWS (L) and the TWS (R) is performed by any of the processing units of the TWS (L) and the TWS (R), but the process of detecting the attached and detached state of the TWS (L) and the TWS (R) may be performed by acquiring necessary information in a processing unit of a device other than the TWS (L) and the TWS (R).

The present technology can also have the following configurations.

(1)

An information processing system including:
a processing unit that determines whether or not a first device and a second device that are attachably and detachably worn on a predetermined portion so as to face each other are in a relationship of facing positions on the basis of a first acceleration and a second acceleration that are accelerations of the first device and the second device, respectively, and detects an attached and detached state of the first device and the second device.
   (2)

The information processing system according to (1), in which the processing unit detects a gravity direction with respect to the first device and the second device on the basis of the first acceleration and the second acceleration, and determines whether or not the first device and the second device are in the relationship of facing positions on the basis of the gravity direction.

(3)

The information processing system according to (1) or (2), in which each of the first device and the second device includes an audio output device.

(4)

The information processing system according to any one of (1) to (3), in which the first device and the second device include earphones worn on left and right ears, respectively.

(5)

The information processing system according to any one of (1) to (4), in which the first device and the second device include true wireless earphones worn on left and right ears, respectively.

(6)

The information processing system according to any one of (1) to (5),
in which the first device and the second device include a first communication unit and a second communication unit that are communication units which perform wireless communication, respectively,
the first communication unit switches the wireless communication between enabled and disabled according to the attached and detached state of the first device, and
the second communication unit switches the wireless communication between disabled and enabled according to the attached and detached state of the second device.
   (7)

The information processing system according to any one of (1) to (6), in which the processing unit acquires acceleration information of at least one of the first acceleration or the second acceleration through wireless communication.

(8)

The information processing system according to (7), in which the acceleration information is transmitted such that the acceleration information is included in an advertising packet when pairing is performed.

(9)

The information processing system according to (7), in which the acceleration information is transmitted as characteristic information of a GATT in data communication of a GATT specification.

(10)

The information processing system according to any one of (7) to (9), in which the wireless communication includes wireless communication conforming to a Bluetooth (registered trademark) Low Energy standard.

(11)

An information processing method including:
by a processing unit of an information processing system including the processing unit, determining whether or not a first device and a second device that are attachably and detachably worn on a predetermined portion so as to face each other are in a relationship of facing positions on the basis of a first acceleration and a second acceleration that are accelerations of the first device and the second device, respectively, and detecting an attached and detached state of the first device and the second device.
   (12)

An information processing system including:
a communication unit that transmits an acceleration of a first device to a second device connected to the first device by wireless communication, through the wireless communication.
   (13)

The information processing system according to (12), in which the communication unit transmits the acceleration such that the acceleration is included in an advertising packet when pairing is performed.

(14)

The information processing system according to (12), in which the communication unit transmits the acceleration as characteristic information of a GATT in data communication of a GATT specification.

(15)

The information processing system according to any one of (12) to (14), in which the wireless communication includes wireless communication conforming to a Bluetooth (registered trademark) Low Energy standard.

### REFERENCE SIGNS LIST

1 Information processing system
11 Smartphone
31 Processing unit
32 Communication unit
51L, 51R Acceleration sensor
52L, 52R Auxiliary sensor
53L, 53R Processing unit
54L, 54R Communication unit
71L Sensor value acquisition unit
71R Sensor value acquisition unit
72L, 72R State determination unit
73L, 73R State storage unit

1. An information processing system comprising:
a processing unit that determines whether or not a first device and a second device that are attachably and detachably worn on a predetermined portion so as to face each other are in a relationship of facing positions on a basis of a first acceleration and a second acceleration that are accelerations of the first device and the second device, respectively, and detects an attached and detached state of the first device and the second device.

2. The information processing system according to claim 1, wherein the processing unit detects a gravity direction with respect to the first device and the second device on a basis of the first acceleration and the second acceleration, and determines whether or not the first device and the second device are in the relationship of facing positions on a basis of the gravity direction.

3. The information processing system according to claim 1, wherein each of the first device and the second device includes an audio output device.

4. The information processing system according to claim 1, wherein the first device and the second device include earphones worn on left and right ears, respectively.

5. The information processing system according to claim 1, wherein the first device and the second device include true wireless earphones worn on left and right ears, respectively.

6. The information processing system according to claim 1,
wherein the first device and the second device include a first communication unit and a second communication unit that are communication units which perform wireless communication, respectively,
the first communication unit switches the wireless communication between enabled and disabled according to the attached and detached state of the first device, and
the second communication unit switches the wireless communication between enabled and disabled according to the attached and detached state of the second device.

7. The information processing system according to claim 1, wherein the processing unit acquires acceleration information of at least one of the first acceleration or the second acceleration through wireless communication.

8. The information processing system according to claim 7, wherein the acceleration information is transmitted such that the acceleration information is included in an advertising packet when pairing is performed.

9. The information processing system according to claim 7, wherein the acceleration information is transmitted as characteristic information of a GATT in data communication of a GATT specification.

10. The information processing system according to claim 7, wherein the wireless communication includes wireless communication conforming to a Bluetooth (registered trademark) Low Energy standard.

11. An information processing method comprising:
by a processing unit of an information processing system including the processing unit, determining whether or not a first device and a second device that are attachably and detachably worn on a predetermined portion so as to face each other are in a relationship of facing positions on a basis of a first acceleration and a second acceleration that are accelerations of the first device and the second device, respectively, and detecting an attached and detached state of the first device and the second device.

12. An information processing system comprising:
a communication unit that transmits an acceleration of a first device to a second device connected to the first device by wireless communication, through the wireless communication.

13. The information processing system according to claim 12, wherein the communication unit transmits the acceleration such that the acceleration is included in an advertising packet when pairing is performed.

14. The information processing system according to claim 12, wherein the communication unit transmits the acceleration as characteristic information of a GATT in data communication of a GATT specification.

15. The information processing system according to claim 12, wherein the wireless communication includes wireless communication conforming to a Bluetooth (registered trademark) Low Energy standard.
